(19) United States
(12) Patent Application Publication
(10) Pub. No.: US 2011/0093132 A1
(43) Pub. Date: Apr. 21, 2011

(54) PLATFORM-INDEPENDENT THERMAL MANAGEMENT OF COMPONENTS IN ELECTRONIC DEVICES

(75) Inventors: Cheng P. Tan, Fremont, CA (US); Keith A. Cox, Campbell, CA (US); Robert B. Sexton, Sunnyvale, CA (US); Joseph J. Castro, San Jose, CA (US); Bryan R. Hoover, San Jose, CA (US)

(73) Assignee: APPLE INC., Cupertino, CA (US)

(21) Appl. No.: 12/581,702

(22) Filed: Oct. 19, 2009

(51) Int. Cl. G05D 23/19

(52) U.S. Cl. 700/299

(57) ABSTRACT

Some embodiments provide a system that manages the temperature of a component in an electronic device. During operation, the system receives, from the component, a temperature offset of the component and a thermal state boundary associated with the temperature offset. Next, the system uses the temperature offset and the thermal state boundary to control the temperature of the component.

### BACKGROUND

1. Field

The present embodiments relate to thermal management of components in electronic devices. More specifically, the present embodiments relate to a method and system for controlling the temperature of a component based on a temperature offset and thermal state boundary associated with the component.

2. Related Art

A modern electronic device often contains a set of tightly packed components. For example, a laptop computer may include a keyboard, display, pointing device, speakers, battery, processor, memory, internal storage, and/or removable media drives in a package that is less than 1.5 inches thick, 8-12 inches long, and 10-15 inches wide. Moreover, most components in the electronic device generate heat, which must be dissipated to prevent immediate failure and improve long-term reliability. For example, heat sinks, cooling fans, heat pipes, and/or vents may be used to facilitate heat dissipation from components in a laptop computer.

However, heat dissipation mechanisms for electronic devices are typically associated with a number of disadvantages. First, different models of a given component may have different heat tolerances and thermal maps. Temperature measurements of the component may thus vary based on the placement of temperature sensors on the component and/or the design of the component. For example, a temperature sensor may measure different values when placed on different areas of the component. In addition, absolute temperature measurements of the component may not consider the component's heat tolerance, which may vary based on the design of the component. Consequently, a temperature reading from a component may correspond to normal operation of the component for some designs and degraded operation of the component for other designs.

On the other hand, temperature measurements of a component may be obtained from an internal temperature sensor through a data interface in the electronic device. While such temperature measurements may be more accurate than measurements obtained from temperature sensors that are arbitrarily placed on the component, transmission of readings from the internal temperature sensor may adversely impact system performance. For example, a hard disk drive (HDD) in a laptop computer may report internal temperature readings through a serial ATA (SATA) interface or Small Computer System Interface (SCSI) with the central processing unit (CPU) of the laptop computer. However, transmission of temperature data through the interface may interrupt normal input/output (I/O) operations with the HDD through the interface. Furthermore, transmission of sensor data through the interface may require the installation of custom drivers that are compatible with the operating system of the laptop computer.

Hence, what is needed is a platform-independent mechanism for obtaining accurate thermal state information from components in an electronic device without impacting performance in the electronic device.

### SUMMARY

Some embodiments provide a system that manages the temperature of a component in an electronic device. During operation, the system receives, from the component, a temperature offset of the component and a thermal state boundary associated with the temperature offset. Next, the system uses the temperature offset and the thermal state boundary to control the temperature of the component.

In some embodiments, the thermal state boundary is associated with at least one of:
(i) a normal operating boundary;
(ii) a degraded operating boundary, wherein the functionality and reliability of the component are compromised;
(iii) a severely degraded operating boundary, wherein data integrity within the component is compromised; and
(iv) a thermal emergency state, wherein the component is at risk of failure.

In some embodiments, the temperature offset and the thermal state boundary are received using a serial interface with the component.

In some embodiments, receiving the temperature offset and the thermal state boundary involves:
(i) receiving a set of temperature offset bits corresponding to the temperature offset;
(ii) receiving a set of thermal state bits corresponding to the thermal state boundary; and
(iii) receiving a fixed bit.

In some embodiments, the fixed bit is used to determine a data rate associated with the serial interface.

In some embodiments, the temperature offset and the thermal state boundary are received by a system management controller in the electronic device.

In some embodiments, the system management controller and the serial interface enable the temperature of the component to be controlled independently of an operating system associated with the electronic device.

In some embodiments, the thermal state boundary is based on a design of the component.

### BRIEF DESCRIPTION OF THE FIGURES

FIG. 1 shows an electronic device in accordance with an embodiment.

FIG. 2 shows a set of data bits associated with the transmission of thermal state information in accordance with an embodiment.

FIG. 3 shows a set of temperature ranges and thermal state boundaries in accordance with an embodiment.

FIG. 4 shows a flowchart illustrating the process of managing the temperature of a component in an electronic device in accordance with an embodiment.

FIG. 5 shows a computer system in accordance with an embodiment.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Embodiments provide a method and system for thermal management of components in electronic devices. The electronic devices may include portable electronic devices, laptop computers, personal computers, servers, workstations, media players, and/or other systems with electronic components. The components may correspond to hard disk drives (HDDs), processors, removable media drives, fan modules, batteries, semiconductor devices, and/or other electronic components that generate heat.

More specifically, embodiments provide a method and system for platform-independent thermal management of components in electronic devices. Such platform-independent thermal management may allow accurate thermal state information regarding a component to be obtained independently of the operating system, design, and/or layout of the component in an electronic device. The thermal state information may be obtained as a temperature offset of the component and a thermal state boundary associated with the temperature offset. The thermal state boundary may characterize the thermal state of the component based on the design of the component and the temperature of the component. For example, the thermal state boundary may correspond to a normal operating boundary; a degraded operating boundary, in which the functionality and reliability of the component are compromised; a severely degraded operating boundary, in which data integrity within the component is compromised; and/or a thermal emergency state, in which the component is at risk of failure. The temperature offset may correspond to a number of degrees below the thermal state boundary.

The thermal state information may additionally be obtained using a serial interface with the component and used to control the temperature of the component. For example, the thermal state information may be used by a system management controller to modulate the speed of cooling fans within the electronic device. Moreover, the use of thermal state boundaries and relative temperature offsets from the thermal state boundaries may allow the component's thermal state to be characterized more accurately than an absolute temperature measurement of the component. Finally, the use of the serial interface and/or system management controller may allow for timely transmission of the thermal state information, as well as thermal management of the component that is independent of the operating system associated with the electronic device.

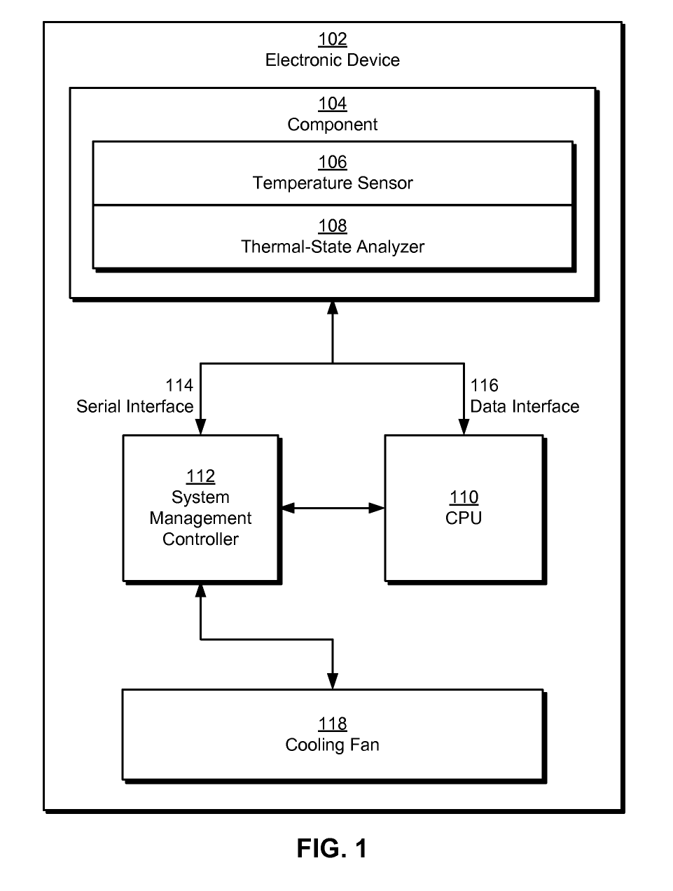

FIG. 1 shows an electronic device 102 in accordance with an embodiment. Electronic device 102 may correspond to a personal computer, laptop computer, server, portable electronic device, media player, and/or other system containing electronic components (e.g., component 104). Along with component 104, electronic device 102 includes a central processing unit (CPU) 110, a system management controller 112, a serial interface 114, a data interface 116, and a cooling fan 118.

Component 104 may correspond to a hard disk drive (HDD), processor, removable media drive, fan module, battery, semiconductor device, and/or other electronic component in electronic device 102. The operation of component 104 may be managed by CPU 110, system management controller 112, and/or another processor in electronic device 102. Furthermore, communication between component 104 and the processor may be facilitated by data interface 116. For example, data interface 116 may correspond to a serial ATA (SATA) interface, Small Computer System Interface (SCSI), and/or a Serial Attached SCSI (SAS).

The operation of component 104 may also generate heat, with increased use of component 104 resulting in a rise in the temperature of component 104. For example, large numbers of input/output (I/O) operations between component 104 and CPU 110 through data interface 116 may cause component 104 to heat up. In addition, excessive heat generation in component 104 may cause component 104 to lose reliability, behave unpredictably, and/or fail prematurely. As a result, electronic device 102 may include thermal management mechanisms for dissipating heat from component 104. For example, a conventional thermal management mechanism may use a temperature sensor 106 in or near component 104 to obtain a temperature measurement that is transmitted to CPU 110 using an Inter-Integrated Circuit (I²C) system bus. CPU 110 may then use the temperature measurement to modulate a fan speed of cooling fan 118, which in turn may keep the temperature of component 104 within an acceptable range.

Those skilled in the art will appreciate that thermal management mechanisms associated with temperature sensor 106, CPU 110, and/or data interface 116 may include a number of drawbacks. First, thermal measurements of component 104 may be affected by time lag and/or the design of component 104. In particular, different models of component 104 may have different heat tolerances. As a result, the same temperature measurement may represent different thermal states for different designs of component 104. Furthermore, temperature measurements from component 104 may vary based on the location of temperature sensors (e.g., temperature sensor 106) on or near component 104 and/or the thermal map of component 104. The accuracy of temperature measurements may also be affected by time lag caused by the transmission of the temperature measurements to CPU 110 (e.g., via an I²C system bus).

On the other hand, high-speed thermal monitoring of component 104 may adversely impact the performance of electronic device 102. In particular, temperature measurements of component 104 that are transmitted to a processor using data interface 116 may interrupt normal I/O with component 104. For example, temperature queries of an internal temperature sensor 106 in an HDD may require the suspension of normal I/O operations through a SATA or SCSI interface with the HDD as temperature readings are obtained from temperature sensor 106. Moreover, thermal management using internal temperature sensors in component 104 and data interface 116 may require the installation of custom drivers for each operating system on electronic device 102.

To facilitate the thermal management of component 104, electronic device 102 may include platform-independent mechanisms for accurately assessing and controlling the thermal state of component 104. In particular, thermal state information may be provided by a thermal-state analyzer 108 in component 104. Thermal-state analyzer 108 may assess the thermal state of component using readings obtained from temperature sensor 106, as well as information associated with the design and/or thermal tolerance of component 104. Consequently, thermal-state analyzer 108 may include functionality to characterize the thermal state of component 104 beyond absolute temperature measurements of component 104.

In one or more embodiments, the thermal state information provided by thermal-state analyzer 108 includes a temperature offset of component 104 and a thermal state boundary associated with the temperature offset. In one or more embodiments, the temperature offset corresponds to a number of degrees below the thermal state boundary of component 104. In other words, the temperature offset may represent the proximity of component 104 to the boundary of a particular thermal state. For example, the temperature offset may track the thermal distance of component 104 from a normal operating thermal boundary; a degraded operating boundary, in which the functionality and reliability of the component are compromised; a severely degraded operating boundary, in which data integrity within the component is compromised; and/or a thermal emergency state, in which the component is at risk of failure. Temperature offsets and thermal state boundaries are discussed in further detail below with respect to FIG. 3.

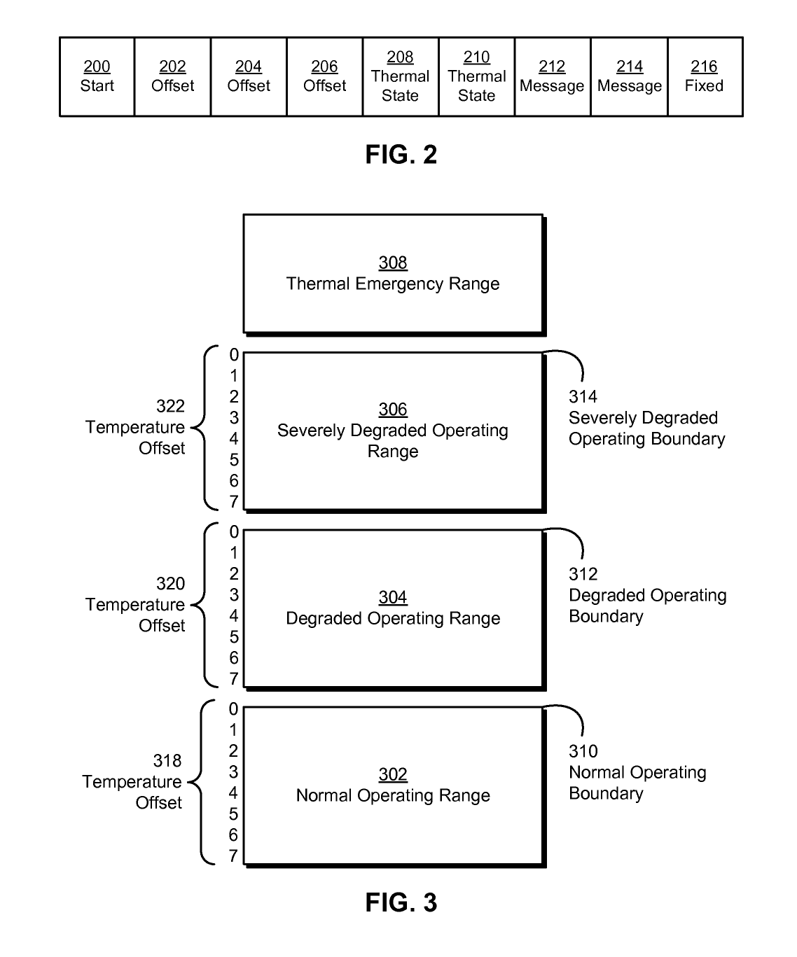

The thermal state information may then be transmitted to system management controller 112 using serial interface 114. Serial interface 114 may include a pin on component 104 and/or a serial port. For example, serial interface 114 may be implemented using a repurposed SATA pin in an HDD and a general-purpose I/O pin on system management controller 112. More specifically, the thermal state information may be transmitted as a set of temperature offset bits corresponding to the temperature offset, a set of thermal state bits corresponding to the thermal state boundary, and a fixed bit that may be used to determine the data rate associated with serial interface 114. Data transmission between component 104 and system management controller 112 using serial interface 114 is discussed in further detail below with respect to FIG. 2.

System management controller 112 may use the thermal state information to control the temperature of component 104. For example, system management controller 112 may modulate the speed of cooling fan 118 based on the thermal state information obtained from component 104. System management controller 112 may also generate warning messages and/or shut down electronic device 102 if thermal state information from component 104 exceeds acceptable bounds and/or the temperature of component 104 cannot be sufficiently controlled by cooling fan 118.

Those skilled in the art will appreciate that the functionality of system management controller 112 may be provided in a variety of ways. For example, system management controller 112 may correspond to one or more processors (e.g., CPU 110, service processor, etc.) and/or microcontrollers in electronic device 102. System management controller 112 may also include one or more software modules that receive and decode signals from serial interface 114 and use the signals to control the temperature of component 104. In other words, system management controller 112 may be implemented using a combination of hardware and/or software modules in electronic device 102.

In one or more embodiments, the use of serial interface 114 to obtain thermal state information from component 104 may mitigate issues associated with time lag in system buses and/or I/O performance in data interface 116. In particular, serial interface 114 may provide a dedicated out-of-band interface for receiving thermal state information from component 104 that does not require the use of performance-critical interfaces such as SCSI or SATA. In addition, the direct connection between component 104 and system management controller 112 provided by serial interface 114 may enable the thermal state information to be received by system management controller 112 in a timely manner, which in turn may allow system management controller 112 to accurately assess and manage the thermal state of component 104.

Moreover, system management controller 112 and serial interface 114 may allow the temperature of component 104 to be controlled independently of an operating system associated with electronic device 102. As mentioned previously, thermal management of component 104 using data interface 116 and CPU 110 may require the installation of custom drivers for each operating system in electronic device 102. However, serial interface 114 and system management controller 112 may bypass the operating system(s) on electronic device 102, thus enabling platform-independent thermal management of component 104 within electronic device 102.

Finally, electronic device 102 may use mechanisms associated with system management controller 112 and/or serial interface 114 to monitor and control other physical properties of component 104 and/or other components in electronic device 102. For example, system management controller 112 may include functionality to monitor and regulate pressure, humidity, acceleration, vibration, light intensity, and/or other physical attributes of components within a mechanical, electrical, and/or other engineering system. Furthermore, the use of offsets and state boundaries to describe each physical property with respect to the component(s) may allow system management controller 112 to manage the physical property independently of design variations in the component(s).

FIG. 2 shows a set of bits 200-216 associated with the transmission of thermal state information in accordance with an embodiment. As described above, bits 200-216 may be transmitted between an electronic component (e.g., component 104 of FIG. 1) and a system management controller (e.g., system management controller 112 of FIG. 1) using a serial interface (e.g., serial interface 114 of FIG. 1). Consequently, bits 200-216 may be transmitted as a frame of RS-232 formatted data containing a start bit 200, eight data bits 202-216, and a stop bit (not shown). This stop bit results in a mandatory period of line inactivity after the transmission of the data frame.

As shown in FIG. 2, bits 202-206 may store a temperature offset associated with the component. The temperature offset may correspond to a number of degrees below a thermal state boundary stored in bits 208-210. For example, a temperature offset of 0 encoded in bits 202-206 (e.g., “000”) may indicate that the component is at the thermal state boundary encoded in bits 208-210, while a temperature offset of 7 encoded in bits 202-206 (e.g., “111”) may indicate that the component is seven degrees below the thermal state boundary encoded in bits 208-210. In other words, if three bits 202-206 are used to encode the temperature offset, a range of 0 to 7 degrees below the thermal state boundary may be represented by the temperature offset.

Similarly, two bits 208-210 may encode up to four thermal state boundaries. For example, an encoding of “00” in bits 208-210 may represent a normal operating thermal boundary. An encoding of “01” may represent a degraded operating boundary, in which the functionality and reliability of the component are compromised. An encoding of “10” may represent a severely degraded operating boundary, in which data integrity within the component is compromised. An encoding of “11” may represent a thermal emergency state, in which the component is at risk of failure.

Bits 212-214 may contain a message code associated with the data stored in bits 202-216. For example, an encoding of “00” in bits 212-214 may specify that the message in bits 202-216 is one byte long, while other encodings may be used for messages of other types and/or lengths (e.g., 5-7 bits).

Finally, bit 216 may store a fixed value (e.g., 0) at the end of every message transmitted using bits 200-216. In one or more embodiments, bit 216 is used to determine a data rate associated with the serial interface. In particular, the interval between the start of bit 200 and the end of bit 216 may be used to calculate a baud rate associated with the transmission of bits 200-216 over the serial interface. For example, the baud rate of the serial interface may be 100 baud if the interval between the start of bit 200 and the end of bit 216 is 90 milliseconds. On the other hand, the serial interface may transmit bits 200-216 at 200 baud if bit the interval between the start of bit 200 and the end of bit 216 is 45 milliseconds.

The calculated baud rate may then be used to identify the individual bits within the frame of data from signals received over the serial interface. The transmission time of each bit and the identification of suitable bit sampling time may be determined by the used of integer division of the frame duration by the number of transmitted bits in conjunction with a continuously updated integer error term. The use of bit 216 to identify the boundaries of the frame, as well as the positions of bits 200-216 within the frame, in conjunction with the error term may enable the transmission of different frames (e.g., from multiple components) of data at different baud rates without handshaking, fine-grained measurement techniques, high-precision time sources, and/or other specialized hardware.

The serial interface may additionally be used to provide information regarding the state of the component between transmissions of frames of bits 202-216. For example, the line voltage of the signal over the serial interface may be held high between transmissions of bits 202-216 during operation of the component. On the other hand, the line voltage of the signal may be held low if the component is asleep and/or unavailable. As a result, the voltage over the serial interface may be used to distinguish between different states of the component; a high voltage may represent an operating state, a low voltage may represent a sleep state, and no voltage (e.g., no signal) may indicate that the component is disconnected or not installed.

Those skilled in the art will appreciate that thermal state information may be allocated among bits 202-216 and/or other bits in various ways. For example, additional bits may be used to encode the thermal state boundary and/or temperature offset if the component has wide operating ranges and/or is to be characterized at a higher granularity. Similarly, multiple frames of data may be used to transmit the thermal state information if more than eight bits 202-216 are required to encode the component's thermal state.

FIG. 3 shows a set of temperature ranges 302-308 and thermal state boundaries 310-314 in accordance with an embodiment. Temperature ranges 302-308 and thermal state boundaries 310-314 may be used to characterize the thermal state of a component, such as component 104 of FIG. 1. In particular, temperature ranges 302-308 may include a normal operating range 302, a degraded operating range 304, a severely degraded operating range 306, and a thermal emergency range 308. Likewise, thermal state boundaries 310-314 may include a normal operating boundary 310, a degraded operating boundary 312, and a severely degraded operating boundary 314.

Normal operating range 302 may correspond to a range of temperatures that represent normal, undegraded operation of the component. For example, the temperature of the component may be in normal operating range 302 if the component is idle and/or operating at low intensity. The top end of normal operating range 302 may be denoted by normal operating boundary 310. Furthermore, if the temperature of the component is within normal operating range 302, the component's thermal state may be reported as a temperature offset 318 of 0 to 7 degrees below normal operating boundary 310 (e.g., using a set of temperature offset bits).

Degraded operating range 304 may correspond to a range of temperatures that represent a decrease in the functionality and reliability of the component. For example, the component may enter degraded operating range 304 if use of the component is heavier than usual. The top end of degraded operating range 304 may be denoted by degraded operating boundary 312. As with normal operating range 302, the component's thermal state may be provided as a temperature offset 320 of 0 to 7 degrees below degraded operating boundary 312 if the component's temperature is in degraded operating range 304.

Severely degraded operating range 306 may correspond to temperatures that indicate a significant loss of integrity in the component. For example, severely degraded operating range 306 may be encountered if the component is being cooled improperly and/or used heavily for an extended period of time. Severely degraded operating boundary 314 may signify the top end of severely degraded operating range 306, and the component's thermal state may be provided as a temperature offset 322 of 0 to 7 degrees below severely degraded operating boundary 314 if the component's temperature is in severely degraded operating range 306.

Finally, thermal emergency range 308 may correspond to a thermal emergency state, in which the component reaches temperatures that represent imminent failure. For example, temperatures in thermal emergency range 308 may indicate that the component is in danger of physically malfunctioning and/or shutting down. In other words, the component may require immediate cooling and/or suspension of use to prevent failure and/or fire if the component's thermal state is reported to be in thermal emergency range 308. Because all temperature offsets within thermal emergency range 308 may be equally bad, temperatures in thermal emergency range 308 may not be provided as offsets.

As mentioned previously, the component's thermal state may be characterized in multiple ways. For example, the component may be associated with only two temperature ranges: an acceptable range and an unacceptable range. The acceptable range may represent normal operation of the component, while the unacceptable range may represent degraded operation of the component. Thus, the component may require additional cooling if the component's temperature enters the unacceptable range. Alternatively, the component may be associated with more than four temperature ranges for finer-grained characterization of the component's thermal state.

Furthermore, temperature ranges and thermal state boundaries of the component may be based on the component's design. For example, the component's thermal tolerance may be based on the manufacturer and/or model of the component. A component with a higher thermal tolerance may include temperature ranges and thermal state boundaries that skew higher than a component with a lower thermal tolerance. Consequently, thermal state information that is based on temperature ranges and thermal state boundaries of the component may allow the component's thermal state to be assessed more accurately than an absolute temperature measurement of the component.

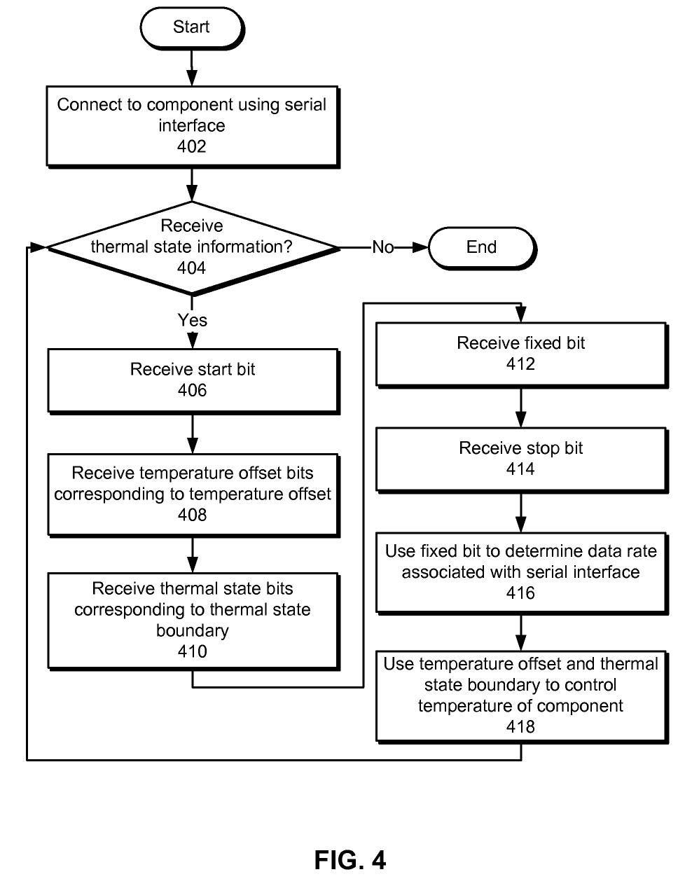

FIG. 4 shows a flowchart illustrating the process of managing the temperature of a component in an electronic device in accordance with an embodiment. In one or more embodiments, one or more of the steps may be omitted, repeated, and/or performed in a different order. Accordingly, the specific arrangement of steps shown in FIG. 4 should not be construed as limiting the scope of the technique.

First, a serial interface is used to connect to the component (operation 402). For example, the serial interface may connect the component and a processor (e.g., system management controller 112 of FIG. 1) used to thermally manage the component. The serial interface may be implemented using one or more pins on the component and processor; alternatively, the serial interface may correspond to a serial port. Thermal state information from the component may be received using the serial interface (operation 404). For example, thermal state information may be periodically obtained (e.g., every five seconds) from the component by the system management controller to monitor the component's thermal state over time.

If the thermal state information is to be received, the thermal state information may be received as a start bit (operation 406), a set of temperature offset bits corresponding to a temperature offset of the component (operation 408), a set of thermal state bits corresponding to a thermal state boundary associated with the temperature offset (operation 410), a fixed bit (operation 412), and a stop bit (operation 414). In particular, the thermal state information may be received as a frame of RS-232 formatted data that is transmitted using the serial interface. The temperature offset may correspond to a number of degrees below the thermal state boundary of the component. The thermal state boundary may correspond to a normal operating boundary, a degraded operating boundary, a severely degraded operating boundary, and/or a thermal emergency state.

The fixed bit is used to determine a data rate associated with the serial interface (operation 416). In particular, the interval of the fixed bit may be used to determine the baud rate of the thermal state information over the serial interface, the length of the frame, and/or the positions of individual bits within the frame. Finally, the temperature offset and the thermal state boundary are used to control the temperature of the component (operation 418). For example, a temperature offset and/or thermal state boundary that indicate possible degradation in the component may be managed by increasing cooling to the component, throttling use of the component, and/or providing additional verification of the component's operation.

Thermal state information may continue to be received from the component (operation 404). For example, thermal state information may be periodically received from the component as long as the component is to be thermally managed. Alternatively, thermal state information may only be received from the component if the component's temperature has risen beyond a certain threshold. If the thermal state information is to be received, the thermal state information is transmitted as a set of bits (operations 406-414), a fixed bit within the set of bits is used to determine the data rate of the transmission (operation 416), and the temperature offset and thermal state boundary encoded within the bits are used to control the temperature of the component (operation 418).

Continuous monitoring and controlling of the component's thermal state may thus be achieved by repeatedly obtaining the thermal state information and using the thermal state information to manage the component's temperature. Periodic receipt of thermal state information from the component may additionally enable tracking of the component's thermal state as the component is used and/or cooled. For example, repeated monitoring of the component's thermal state may allow the component's approach towards a given thermal state boundary to be tracked and/or handled.

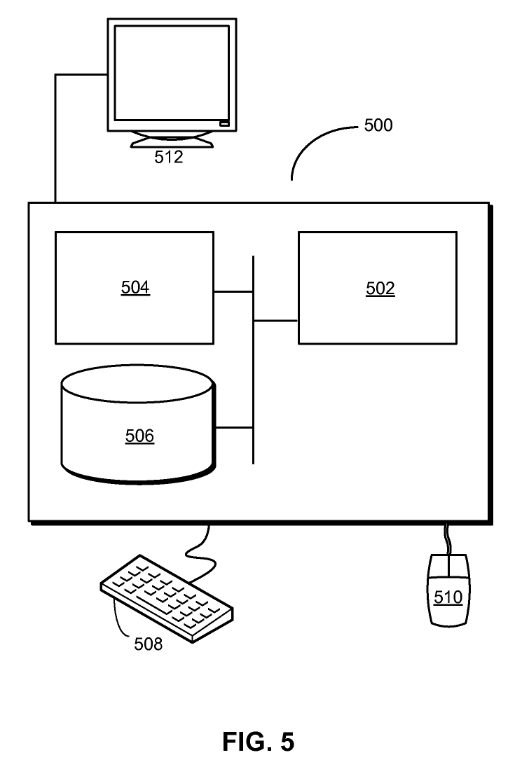

FIG. 5 shows a computer system 500 in accordance with an embodiment. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In particular, computer system 500 may provide a system for managing the temperature of a component in an electronic device. The system may include a system management controller and a serial interface connecting the system controller and the component. The system management controller may obtain, using the serial interface, a temperature offset of the component and a thermal state boundary associated with the temperature offset. The system management controller may also use the temperature offset and the thermal state boundary to control the temperature of the component. For example, the system management controller may modulate the speed of a cooling fan to cool the component, throttle use of the component, and/or provide additional verification of the component's operation.

In addition, one or more components of computer system 500 may be remotely located and connected to the other components over a network. Portions of the present embodiments (e.g., serial interface, system management controller, cooling fan, component, etc.) may also be located on different nodes of a distributed system that implements the embodiments. For example, the present embodiments may be implemented using a cloud computing system that provides a remote thermal management system for a set of computer systems and/or electronic devices.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for managing the temperature of a component in an electronic device, comprising:
receiving, from the component, a temperature offset of the component and a thermal state boundary associated with the temperature offset; and
using the temperature offset and the thermal state boundary to control the temperature of the component.

2. The method of claim 1, wherein the thermal state boundary is associated with at least one of:
a normal operating boundary;
a degraded operating boundary, wherein the functionality and reliability of the component are compromised;
a severely degraded operating boundary, wherein data integrity within the component is compromised; and
a thermal emergency state, wherein the component is at risk of failure.

3. The method of claim 1, wherein the temperature offset and the thermal state boundary are received using a serial interface with the component.

4. The method of claim 3, wherein receiving the temperature offset and the thermal state boundary involves:
receiving a set of temperature offset bits corresponding to the temperature offset;
receiving a set of thermal state bits corresponding to the thermal state boundary; and
receiving a fixed bit.

5. The method of claim 4, wherein the fixed bit is used to determine a data rate associated with the serial interface.

6. The method of claim 3, wherein the temperature offset and the thermal state boundary are received by a system management controller in the electronic device.

7. The method of claim 6, wherein the system management controller and the serial interface enable the temperature of the component to be controlled independently of an operating system associated with the electronic device.

8. The method of claim 1, wherein the thermal state boundary is based on a design of the component.

9. A system for managing the temperature of a component in an electronic device, comprising:
a serial interface connecting the component and a system management controller; and
the system management controller configured to:
obtain, using the serial interface, a temperature offset of the component and a thermal state boundary associated with the temperature offset; and
use the temperature offset and the thermal state boundary to control the temperature of the component.

10. The system of claim 9, wherein the thermal state boundary is associated with at least one of:
a normal operating boundary;
a degraded operating boundary, wherein the functionality and reliability of the component are compromised;
a severely degraded operating boundary, wherein data integrity within the component is compromised; and
a thermal emergency state, wherein the component is at risk of failure.

11. The system of claim 9, wherein receiving the temperature offset and the thermal state boundary involves:
receiving a set of temperature offset bits corresponding to the temperature offset;
receiving a set of thermal state bits corresponding to the thermal state boundary; and
receiving a fixed bit.

12. The system of claim 11, wherein the fixed bit is used to determine a data rate associated with the serial interface.

13. The system of claim 9, wherein the temperature offset corresponds to a number of degrees below the thermal state boundary of the component.

14. The system of claim 9, wherein the system management controller and the serial interface enable the temperature of the component to be controlled independently of an operating system associated with the electronic device.

15. The system of claim 9, wherein the thermal state boundary is based on a design of the component.

16. The system of claim 9, wherein the component is at least one of a hard disk drive, a processor, a removable media drive, a fan module, a battery, and a semiconductor device.

17. A computer-readable storage medium storing instructions that when executed by a computer cause the computer to perform a method for managing the temperature of a component in an electronic device, the method comprising:
receiving, from the component, a temperature offset of the component and a thermal state boundary associated with the temperature offset; and
using the temperature offset and the thermal state boundary to control the temperature of the component.

18. The computer-readable storage medium of claim 17, wherein the thermal state boundary is associated with at least one of:
a normal operating boundary;
a degraded operating boundary, wherein the functionality and reliability of the component are compromised;
a severely degraded operating boundary, wherein data integrity within the component is compromised; and
a thermal emergency state, wherein the component is at risk of failure.

19. The computer-readable storage medium of claim 17, wherein the temperature offset and the thermal state boundary are received using a serial interface with the component.

20. The computer-readable storage medium of claim 19, wherein receiving the temperature offset and the thermal state boundary involves:
receiving a set of temperature offset bits corresponding to the temperature offset;
receiving a set of thermal state bits corresponding to the thermal state boundary; and
receiving a fixed bit.

21. The computer-readable storage medium of claim 20, wherein the fixed bit is used to determine a data rate associated with the serial interface.

22. The computer-readable storage medium of claim 19, wherein the temperature offset and the thermal state boundary are received by a system management controller in the electronic device.

23. The computer-readable storage medium of claim 22, wherein the system management controller and the serial interface enable the temperature of the component to be controlled independently of an operating system associated with the electronic device.

24. The computer-readable storage medium of claim 17, wherein the thermal state boundary is based on a design of the component.
